(19) United States
(12) Patent Application Publication
(10) Pub. No.: US 2024/0330967 A1
(43) Pub. Date: Oct. 3, 2024

(54) SYSTEMS AND METHODS FOR OPTIMAL REPLACEMENT COMPONENT PRICING

(71) Applicant: Caterpillar Inc., Peoria, IL (US)

(72) Inventor: Lucas Inoue Sardenberg, Oak Park, IL (US)

(21) Appl. No.: 18/743,517

(22) Filed: Jun. 14, 2024

Related U.S. Application Data
(63) Continuation of application No. 17/410,874, filed on Aug. 24, 2021.

(51) Int. Cl. G06Q 30/0201; G06Q 10/20

(52) U.S. Cl. CPC G06Q 30/0206; G06Q 30/0201; G06Q 10/20

(57) ABSTRACT

The present technology is generally directed to systems and methods for determining a customer-specific price for a replacement component of a machine. The present technology can include collecting, for one or more customers, data associated with the replacement component. For each of the customer(s), the present technology can further include determining one or more customer-specific factors; using the customer-specific factors(s) to determine one or more optimization metric(s); applying an optimization engine to the optimization metric(s) to determine a customer-specific adjustment; and inputting the customer-specific adjustment into a pricing system to generate a future price for the replacement component.

### CROSS-REFERENCE TO RELATED APPLICATIONS

This application is a continuation of U.S. patent application Ser. No. 17/410,874, filed on Aug. 24, 2021, which is hereby incorporated by reference in its entirety.

### TECHNICAL FIELD

The present disclosure relates to systems and methods for determining optimal pricing for replacement components, including determining customer-specific replacement component prices using optimization metrics based on data associated with the replacement components.

### BACKGROUND

Equipment (such as machines or vehicles) often require maintenance, which may include repairing or replacing one or more components. Equipment owners often purchase replacement components from component retailers. Component retailers typically price components based on manufacturing costs or other information about their business, and thus may not provide their customers with optimal prices. In most cases, the volume of components and the number of customers can make providing optimal, customer-specific prices resource intensive and time consuming.

Efforts have been made to provide optimal prices for products. For example, U.S. Pat. Pub. App. No. 2016/0232546 to Ranft et al (hereinafter “Ranft”) describes using a computer to generate current putative prices for financial products, where the putative price represents a price that a consumer ought to be willing to pay for the financial products in a competitive market. Ranft then describes providing customers with recommended financial products based on the putative price. However, Ranft does not describe providing optimal, customer-specific prices for the financial products. Additionally, Ranft does not describe providing optimal, customer-specific prices for components of a machine.

### SUMMARY

In some embodiments, the present technology includes a method for determining a customer-specific price for a replacement component of a machine. The method can include collecting, for one or more customers, data associated with the replacement component. In some embodiments, the customer data includes (i) component price data comprising a past price for the replacement component by the one or more customers, (ii) component purchase data comprising a past quantity of the replacement component purchased by the one or more customers, and/or (iii) customer metric data for the one or more customers. For each of the one or more customers, the method can further include: determining, for each of the customer data associated with the customer, a customer-specific weight and a customer-specific score; combining, for each of the customer data, the customer-specific weight with the corresponding customer-specific score to determine an optimization metric; applying an optimization engine to the optimization metric for each of the customer data to determine a customer-specific adjustment for the replacement component; and inputting the customer-specific adjustment into a pricing system to generate a future price for the replacement component specific to the customer.

In some embodiments, the present technology includes a method for determining a future price for a component of a machine. The method can include: (i) collecting component data associated with the component; (ii) determining, for each of the component data associated with the component, a component-specific weight and a component-specific score; (iii) combining, for each of the component data, the component-specific weight with the corresponding component-specific score to determine an optimization metric; (iv) applying an optimization engine to the optimization metric for each of the component data to determine a component-specific adjustment for the component; and/or (v) inputting the component-specific adjustment into a pricing system to generate a future price for the component.

In some embodiments, the present technology includes one or more non-transitory computer-readable media storing computer-executable instructions that, when executed by one or more processors, cause the one or more processors to perform a method. The method can include collecting, for one or more customers, data associated with the replacement component. The customer data can include: component price data comprising a past price for the replacement component by the one or more customers; component purchase data comprising a past quantity of the replacement component purchased by the one or more customers; and/or customer metric data for the one or more customers. For each of the one or more customers, the method can further include: determining, for each of the customer data associated with the customer, a customer-specific weight and a customer-specific score; combining, for each of the customer data, the customer-specific weight with the corresponding customer-specific score to determine an optimization metric; applying a pricing optimization engine to the optimization metric for each of the customer data to determine a customer-specific adjustment for the replacement component; and/or inputting the customer-specific adjustment into a pricing system to generate a future price for the replacement component specific to the customer.

Other aspects will appear hereinafter. The features described herein can be used separately or together, or in various combinations of one or more of them.

### BRIEF DESCRIPTION OF THE DRAWINGS

Many aspects of the present technology can be better understood with reference to the following drawings. The components in the drawings are not necessarily drawn to scale. Instead, emphasis is placed on illustrating clearly the principles of the present technology. Furthermore, components can be shown as transparent in certain views for clarity of illustration only and not to indicate that the component is necessarily transparent. Components may also be shown schematically.

FIG. 1 is an illustration of customer fleets including equipment and components, in accordance with select embodiments of the present technology.

FIG. 2A is a block diagram illustrating a method of determining a customer-specific price for a replacement component, in accordance with select embodiments of the present technology.

FIG. 2B is a schematic illustration of a step of the method of FIG. 2A, in accordance with embodiments of the present technology

FIG. 3A is a block diagram illustrating a method of determining customer-specific replacement component prices for a plurality of customers, in accordance with select embodiments of the present technology.

FIG. 3B is a block diagram illustrating a method of determining one or more component-specific prices for one or more components of a machine, in accordance with select embodiments of the present technology.

FIG. 4 is a block diagram illustrating a method of using a first customer-specific price for a first replacement component to determine a second customer-specific adjustment for a second component, in accordance with embodiments of the present technology.

FIG. 5 is a block diagram illustrating an overview of devices on which some implementations can operate;

FIG. 6 is a block diagram illustrating an overview of an environment in which some implementations can operate; and

FIG. 7 is a block diagram illustrating elements which, in some implementations, can be used in a system employing the disclosed technology.

The drawings have not necessarily been drawn to scale. For example, the dimensions of some of the elements in the figures may be expanded or reduced to help improve the understanding of the embodiments. Moreover, while the disclosed technology is amenable to various modifications and alternative forms, specific embodiments have been shown by way of example in the drawings and are described in detail below. The intention, however, is not to unnecessarily limit the embodiments described. Rather, the embodiments are intended to cover all modifications, combinations, equivalents, and alternatives falling within the scope of this disclosure.

### DETAILED DESCRIPTION

Various embodiments of the present technology will now be described in further detail. The following description provides specific details for a thorough understanding and enabling description of these embodiments. One skilled in the relevant art will understand, however, that the techniques and technology discussed herein may be practiced without many of these details. Likewise, one skilled in the relevant art will also understand that the technology can include many other features not described in detail herein. Additionally, some well-known structures or functions may not be shown or described in detail below so as to avoid unnecessarily obscuring the relevant description. Accordingly, embodiments of the present technology may include additional elements or exclude some of the elements described below with reference to the Figures, which illustrate examples of the technology.

The terminology used in this description is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such.

The present technology is generally directed to methods and systems for determining a customer-specific price for determining optimal, customer-specific prices for replacement components of machines or other equipment, in part by collecting data associated with the replacement components and corresponding to the customers. The optimal, customer-specific prices are based on data such as component price data (including a past price for the replacement component paid by each of the customers), component purchase data (including a past quantity of the replacement component purchased by each of the customers), customer metric data, and other data described in greater detail below. Systems and methods configured in accordance with embodiments of the present technology determine optimal, customer-specific prices for replacement components, e.g., to maximize the profitability of replacement component transactions. In some embodiments, systems and methods configured in accordance with embodiments of the present technology determine or adjust incentives offered to replacement component dealers, e.g., to incentivize said dealers to sell replacement components at the optimal, customer-specific prices.

### Replacement Component Pricing, and Associated Systems, Device, and Methods

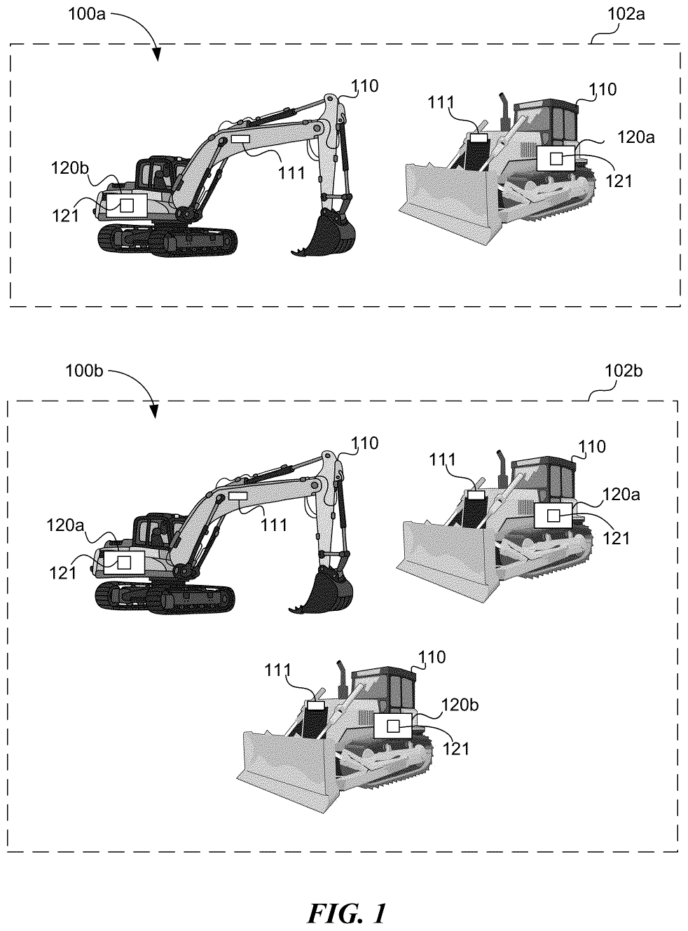

FIG. 1 is an illustration of one or more customer fleets 100 in accordance with embodiments of the present technology. In the illustrated embodiment, for example, the one or more customer fleets 100 include a first customer fleet 100a and a second customer fleet 100b (“the fleet(s) 100”). Each of the fleet(s) 100 can correspond to one or more customers 102. In the illustrated embodiment, for example, the one or more customers 102 includes a first customer 102a and a second customer 102b (“the customer(s) 102”). Each of the fleet(s) 100 can include one or more equipment or machine(s) 110. The machines 110 can include at least one of a truck, a tracked-type tractor, an excavator, a wheel loader, a front-end loader, a motor grader, a vehicle, an industrial machine, and/or any other suitable machine. The machine(s) 110 can be associated with a machine identifier 111 (shown schematically). The machine identifier 111 can include a name, number, serial number, alphanumeric, and/or any other suitable machine identifier. The machine(s) 110 can include one or more components or parts 120a (shown schematically) functioning together or independently to perform activities associated with the machine 110. For example, the machine(s) 110 can have parts 120a including an engine (and components thereof), a transmission, input devices (such as steering components), tires, tracks, hydraulic systems, sensors, solenoids, actuators, and any other suitable parts of the machine(s) 110. The machine(s) 110 may be subject to maintenance or repair such that one or more of the machine(s) 110 may include or require one or more replacement components or parts 120b (shown schematically). The replacement components 120b can be generally similar to or the same as the parts 120a. Both the components 120a and the replacement components 120b can be associated with a component identifier 121 (shown schematically). The component identifier 121 can include a name, number, serial number, alphanumeric, and/or any other suitable component identifier. In some embodiments, the customer(s) 102 can purchase the replacement components 120b from a manufacturer, a vendor, a dealer, and/or any other suitable source of replacement components 120b. In some embodiments, and as described in greater detail below, each of the replacement components 120b can have one or more prices, and each price can be optimal and/or specific to a customer (e.g., for each customer, the replacement component can have an optimal, customer-specific price).

Although the embodiment in FIG. 1 illustrates two fleets 100a-b and two corresponding customers 102a-b, other embodiments can include more or fewer fleet(s) 100 and/or customer(s) 102, such as at least one, five, ten, fifty, one-hundred, or any other suitable number of fleets 100 and/or customers 102. In some embodiments, the number of fleets 100 corresponds to (e.g., is the same as) the number of customers 102. Although the embodiment in FIG. 1 shows the first fleet 100a having two machines 110 and the second fleet 100b having three machines 110, in other embodiments each of the fleets 100 can include more or fewer machines 110, such as at least one, five, ten, fifty, one-hundred, one-thousand, or any other suitable number of machines 110.

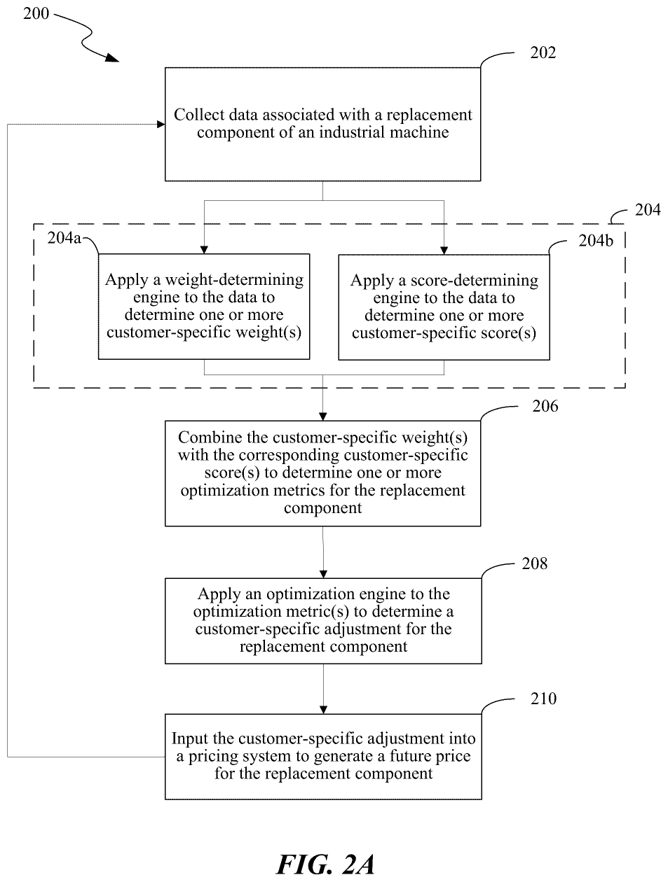

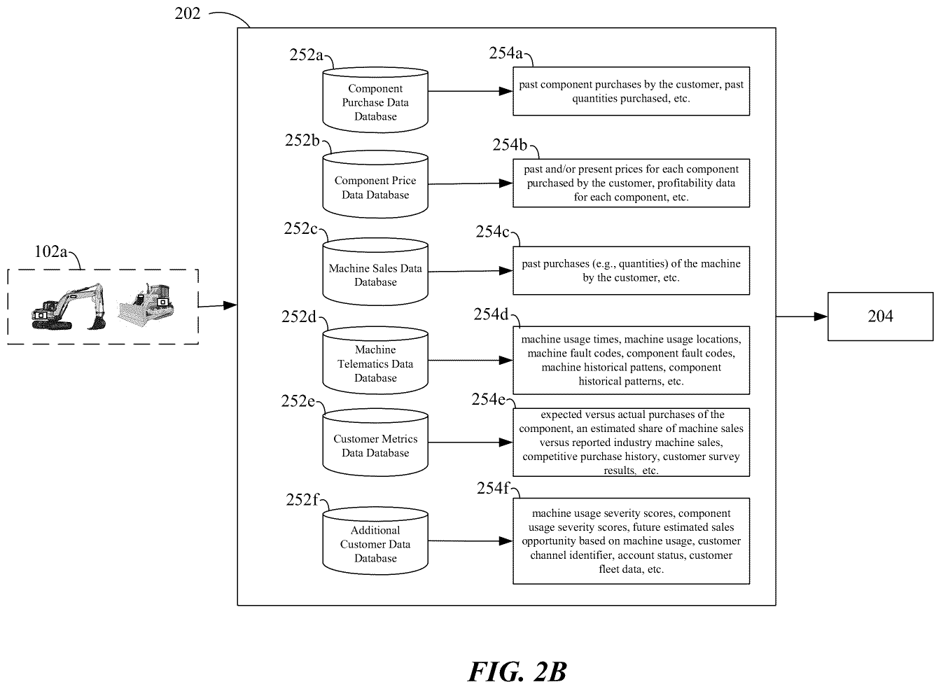

FIG. 2A is a block diagram illustrating a method 200 of determining a customer-specific price for a component of a machine 110 in accordance with select embodiments of the present technology. The component can be generally similar to or the same as the components 120a and/or the replacement components 120b of FIG. 1 (referred to hereinafter as “the component 120”). The components 120 can be associated with a component identifier, such as a component name, a component number, a component serial number, and/or any other suitable component identifier. Similarly, the machine 110 can be associated with a machine identifier, such as a machine name, a machine number, a machine serial number, and/or any other suitable machine identifier.

At step 202, the method 200 includes collecting or receiving one or more data or datasets associated with the component 120. The collected data can be further associated with a customer, such as the customer 102a or 102b of FIG. 1. In some embodiments, the customer may have previously purchased the component 120, may currently own the component 120, and/or may currently own one or more machines 110 including the component 120. The customer can be associated with a customer identifier, such as a customer name, a customer number, a customer serial number, and/or any other suitable customer identifier. Accordingly, the collected customer data can be associated with the corresponding customer identifier(s) and component identifier(s), such that the collected data can be customer-specific and component-specific.

FIG. 2B is a schematic illustration of step 202 of the method 200, in accordance with embodiments of the present technology. Referring to FIGS. 2A and 2B together, in some embodiments step 202 can include accessing one or more databases to collect the data associated with the component 120. For example, as best seen by FIG. 2B, step 202 can include accessing a component purchase data database 252a, a component price data database 252b, a machine sales data database 252c, a machine telematics data database 252d, a customer metrics data database 252c, and/or one or more additional databases 252f including data associated with the component 120 and/or the customer (“the databases 252”). Each of the databases 252 can include various types of data associated with the component and/or the customer. For example, the component purchase data database 252a can include component purchase data 254a, the component price data database 252b can include component price data 254b, the machine sales data database 252c can include machine sales data 254c, the machine telematics data database 252d can include machine telematics data 254d, the customer metrics data database 252e can include customer metrics data 254c, and/or the one or more additional databases 252f can include any other suitable data 254f (“the data 254”).

Accordingly, step 202 can include collecting one or more of the following data 254:
(i) the component purchase data 254a, including, for example, past purchases (e.g., purchased quantities) of the component 120 by the customer;
(ii) the component price data 254b, including, for example, past and/or present prices for each component 120 purchased by the customer, and/or profitability data (e.g., revenue, net profit, and/or gross profit) for each component 120;
(iii) the machine sales data 254c, including, for example, past purchases (e.g., quantities) of the machine 110 by the customer (e.g., by machine identifier and/or vendor);
(iv) the machine telematics data 254d, including, for example, one or more machine 110 usage times (e.g., in hours), machine usage locations (e.g., geographic coordinates, a city, a state, a country, etc.), machine fault codes, component fault codes, machine historical patterns (e.g., maintenance and/or repair history, machine tasks, job assignments, etc.), and/or component historical patterns (e.g., maintenance and/or repair history and/or machine fuel consumption rate, volume, etc.);
(v) the customer metrics data 254e can include, for example, loyalty scores for the customer based on expected versus actual purchases of the component 120 over the operational life of the machine 110, an estimated share of machine business or dealer machine sales versus reported industry machine sales, competitive purchase history, and/or customer survey results; and/or
(vi) the other suitable customer data 254f can include, for example, machine 110 usage severity scores, component usage severity scores, future estimated sales opportunity based on machine usage, a customer channel identifier (e.g., one or more dealers or vendors from which customer(s) has purchased parts, machines, etc.), account status with one or more dealers (e.g., whether the customer is late/on time with payments, etc.), and/or customer fleet data (e.g., a number and/or type of machines and/or equipment owned and/or operated by the customer(s), etc.)

Each of the data 254 can be collected from a corresponding database (e.g., the component purchase data 254a can be collected from the component purchase data database 252a, the component price data 254b can be collected from the component price data database 252b, etc.). Each of the databases 252 can include data 254 from one or more invoices, work orders, component orders, other databases, and/or any other suitable data source.

In some embodiments, the collected data 254 can correspond to one or more time periods. In at least some embodiments, for example, the component purchase data 254a can represent the past component purchases for each of the customers over the time period(s). The time period(s) can include a time of at least one day, one week, one month, three months, six months, one year, five years, ten years, or any other suitable time.

Any of the collected data 254 can be associated with one or more corresponding identifiers, such as one or more names, numbers, alphanumeric codes, and/or any other suitable identifier that represents the collected data. This can be generally similar to or the same as the machine identifier 111 and/or the component identifier 121 of FIG. 1. For example, the component purchase data 254a can be represented by one or more component purchase or quantity identifiers, the component price data 254b can be represented by one or more component price identifiers, the machine sales data 254c can be represented by one or more machine sales identifiers, the machine telematics data 254d can be represented by one or more machine telematics identifiers (e.g., a usage time identifier, a usage location identifier, a fault code identifier, etc.), the customer metrics data 254c can be represented by one or more customer metrics identifiers, etc.

Although, in the illustrated embodiment, the method 200 includes collecting the data 254 for a single component, in other embodiments the method 200 can include collecting data for more components. In at least some embodiments, for example, the data 254 can be collected for at least two, five, ten, one hundred, one thousand, one hundred thousand, or more components. Additionally, the data 254 can be collected for one or more customers, such as at least two, ten, one hundred, one thousand, or more customers.

Once the data 254 is collected, the method 200 can continue to step 204.

Referring again to FIG. 2A, at step 204, the method 200 can further include analyzing the data 254 (Step 202) to determine one or more customer-specific factors. In some embodiments, step 204 can include one or more substeps performed in parallel or in sequence, and each substep can correspond to a score and/or weight. In the illustrated embodiment, for example, at substep 204a the method 200 includes applying a weight-determining engine to the collected data 254 (step 202) to determine one or more customer-specific weights. The weight-determining engine can be configured to run descriptive and/or predictive analytics to determine the customer-specific weight(s) for the data 254. This can include using one or more classification models, or any other suitable machine learning model, to determine whether individual ones of the data (e.g., the component purchase data and/or one or more aspects thereof, etc.) are associated with a “high,” “medium,” or “low” likelihood that the customer will need to purchase the replacement component. In other embodiments, the customer-specific weights can include values, probabilities, or any other suitable weights. Each weight can represent a prediction of how the associated data 254 influences or is correlated with the likelihood or probability the customer purchases the replacement component. For example, a relatively high machine usage time can be associated with a high likelihood, and a relatively low machine usage time can be associated with a low likelihood. The high, medium, and/or low likelihoods can be predetermined (e.g., by a user) or identified by the model(s). Accordingly, in some embodiments substep 204a can include determining a plurality of customer-specific weights, where, for the customer, each customer-specific weight corresponds to one of the data associated with said customer (e.g., a first customer-specific weight for the component purchase data, a second customer-specific weight for the component price data, etc.).

Additionally, in the illustrated embodiment, at substep 204b the method 200 includes applying a score-determining engine to the collected data 254 (step 202) to determine a customer-specific score. The score-determining engine can be configured to determine whether and/or to what extent each of the data influence and/or are correlated with the likelihood that the customer purchases the replacement component. This can include analyzing the collected data 254 (step 202) to determine one or more correlations or trends. For example, a customer having relatively high machine usage time data may nevertheless purchase fewer replacement components than expected. Thus, the score-determining engine can assign a score to the machine usage time data for said customer indicating that said data has a reduced correlation with and/or a relatively low effect on the likelihood the customer purchases the replacement component. As another example, changes in a customer's price data (e.g., component price data 254b) may be correlated with the likelihood of purchasing the replacement component, such that decreases in price are associated with an increase in likelihood, and increases in price are associated with a decrease in the likelihood. Thus, the score-determining engine can assign a score to the component price data 254b for said customer indicating that said data has an increased or relatively high effect on the likelihood the customer purchases the replacement component. As another example, a customer's purchase quantity data may remain generally or substantially constant over a time period, e.g., regardless of changes in one or more other data associated with said customer, e.g., the component price data, etc. Thus, if the customer metric data 254c (e.g., expected versus actual purchases) indicate that the quantity purchased is generally similar to or the same as the expected quantity purchased, the score-determining engine can assign a score to the one or more other data to indicate that the one or more other data have a reduced correlation with and/or a relatively low effect on the likelihood the customer purchases the replacement component. Accordingly, in some embodiments substep 204b can include determining a plurality of customer-specific scores, where, for the customer, each customer-specific score can correspond to one of the data 254 associated with said customer's data associated with said customer (e.g., one or more first customer-specific scores for each of the component purchase data 254a, one or more second customer-specific scores for each of the component price data 254b, etc.). The score-determining engine can include one or more machine learning models, rule-based models, and/or any other suitable models.

At step 206, the method 200 can further include combining the customer-specific weights and the customer-specific scores of step 204 to determine one or more optimization metrics. For a given one of the data (step 202), step 206 can include combining the customer-specific weight determined for said data with the customer-specific score determined for said data (e.g., step 204). This can include, for example, determining a weighted aggregation of the corresponding weights and scores for the data. In some embodiments, combining the customer-specific weights and the customer-specific scores can include creating a ranked or ordered list of each of the data (e.g., step 204) from most-likely to influence and/or most-correlated with a customer's likelihood of purchasing the replacement component to least-likely to influence and/or least-correlated with the customer's likelihood of purchasing the replacement component. In some embodiments, the data can be ranked or ordered based on one or more dimensions, such as a machine type dimension, a component price dimension, a component type dimension, a component profitability dimension, a customer channel identifier dimension, and/or any other suitable dimension. Accordingly, each optimization metric can correspond to one of the data, such that each of the data can be associated with an optimization metric comprising the corresponding customer-specific weight and customer-specific score. Thus, each of the optimization metrics can be customer-specific and component-specific. In at least some embodiments, for example, calculating the one or more optimization metrics can include calculating a first optimization metric for a first customer and calculating a second optimization metric for a second customer.

At step 208, the method 200 can further include applying an optimization engine to the optimization metric(s) of step 206 to determine a customer-specific adjustment. Because the optimization metric(s) are specific the customer, the customer-specific adjustments can also be specific to the customer. Moreover, because the optimization metric(s) are based on the data 254 collected for the replacement component (step 202), the customer-specific adjustment can be specific to the replacement component. Accordingly, the customer-specific adjustment can be specific to both the customer and the replacement component (e.g., customer-specific and component-specific).

The optimization engine can include one or more models programmed to determine the customer-specific adjustment so as to optimize (e.g., maximize) one or more aspects of a future transaction involving the component of step 202. The optimization engine can optimize, for example, a price paid for the component and/or a quantity of the component purchased. In some embodiments, the pricing optimization engine can optimize a customer loyalty metric, such as a ratio of a past quantity of the component purchased with a total number of the component owned, and/or any other customer data described herein. The one or more models of the pricing optimization engine can include one or more machine learning models, deep learning models, deep learning models including optimization with gradient boosting, Monte Carlo experiments for sales probability, decision trees for combining customer data, and/or any other suitable models. The one or more customer-specific adjustments can include a change in price of the component of step 202, such as an increase or a decrease in price relative to the price identifier (e.g., the past price paid per component) of step 202.

At step 210, the method 200 can further include inputting the customer-specific adjustment of step 208 into a pricing system to generate a future price for the component of step 202. Because the customer-specific adjustment can be specific to both the customer and the replacement component (e.g., customer-specific and component-specific), the future price can similarly be specific to both the customer and the replacement component (e.g., customer-specific and component-specific). In some embodiments the future price can be or include an offset (e.g., an offset in a base price, a default price, a market price, etc.); a discount in price, a further discount (e.g., a discount in addition to a previously offered discount or other alteration in price); and/or a time- or use-based multiplier for the price, offset, and/or discount.

In some embodiments, the method 200 can further include offering the future price to the corresponding customer. In other embodiments, the method can further include providing the future price as a suggested price to a dealer, such that the dealer can offer the future price to the corresponding customer. In such embodiments, the method 200 can further include at least one of the following:
(i) identifying a deviation in paid price, such as a deviation between the suggested price (e.g., the future price of step 210) and a price actually paid by the customer to the dealer;
(ii) comparing the customer-specific adjustment to the deviation in paid price; and/or
(iii) adjusting one or more incentives associated with the component, such as one or more incentives (e.g., bulk discounts, discounts for specific replacement component(s), sales support, merchandise programs, corporate account discounts, etc.) provided to dealers to incentivize dealers to reduce or minimize sales of components at prices deviated from the future price.

The deviation in paid price can be based at least in part on data (e.g., the data 254) associated with the component(s) and/or the customer(s). In some embodiments, generating the future price (step 210) can include adjusting for one or more environmental and/or temporal factors. The one or more environmental and/or temporal factors can include a geographic location, a season (spring, summer, winter, fall, etc.), and/or any other suitable environmental and/or temporal factor. In at least some embodiments, for example, the method 200 can include increasing the future price in a first geographic location and decreasing the future price in a second, different geographic location. As another example, in at least some embodiments the method 200 can include increasing the future price during a first season (e.g., summer) and decreasing the future price during a second, different season (e.g., winter). The one or more environmental and/or temporal factors can be customer-specific, such that the adjustment based on the one or more environmental and/or temporal factors can also be customer-specific. In at least some embodiments, the future price (step 210) can be based on all the data (e.g., the data 254 of FIG. 2B) associated with a given customer.

In some embodiments, the method 200 can further include repeating one or more of the steps 202-210. In at least some embodiment, for example, the method 200 can run one or more times (e.g., iteratively, in sequence, in parallel, etc.) and include using the (first) customer-specific adjustment(s) (step 208) and/or the (first) determined future price(s) (step 210) to determine one or more second customer-specific adjustments and/or second future prices.

The following examples are intended to illustrate how, for one or more customers and their associated customer data, the method 200 can produce one or more customer-specific price adjustments, and should not be viewed as limitations or requirements of the present technology. Moreover, it can be appreciated that the method 200 is not limited to the specific data described below, and can include any one or combination of the data described herein.

As a first example, data is collected (e.g., step 202) for a first customer. The data can indicate that the first customer is loyal (e.g., purchases 50% of total potential parts from a given dealer) but that the first customer purchases a relatively low volume of replacement components (e.g., compared to other customers). The data about the first customer is used to determine one or more customer-specific factors (e.g., step 204) for each of the parts purchased by the first customer. The customers-specific factor(s) are used to determine one or more optimization metrics (e.g., step 206). Based on the optimization metric(s), the method 200 determines an adjustment for each of the parts and that is specific to the first customer (e.g., step 208). For example, the adjustment can be a decrease in the price of one or more parts that have high profitability but that the first customer is not purchasing. The one or more adjustments specific to the first customer can be input into a pricing system (e.g., step 210) to generate a future price for each of the first parts. Thus, for the first customer, the method 200 can optimize (e.g., maximize) sale profitability for one or more replacement components.

As a second example, data is collected (e.g., step 202) for a second customer. The data can indicate that the second customer has a relatively small fleet (e.g., relatively few machines/equipment), but purchases a relatively large volume of replacement components. The data about the second customer is used to determine one or more customer-specific factors (e.g., step 204) for each of the components purchased by the second customer. The customers-specific factor(s) are used to determine one or more optimization metrics (e.g., step 206). Based on the optimization metric(s), the method 200 determines a customer-specific adjustment for each of the parts (e.g., step 208). For example, the customer-specific adjustment can maintain generally similar or the same prices for the components, and/or can increase the price for low-profitability components. The adjustments can be input into a pricing system (e.g., step 210) to generate a future price for each of the components. Thus, for the second customer, the method 200 can optimize (e.g., maximize) sale profitability for one or more replacement components.

As a third example, data is collected (e.g., step 202) for a third customer. The data can indicate that the third customer has a relatively small fleet and purchases a relatively small volume of replacement components. The data about the third customer is used to determine one or more customer-specific factors (e.g., step 204) for each of the components purchased by the third customer. The customers-specific factor(s) are used to determine one or more optimization metrics (e.g., step 206). Based on the optimization metric(s), the method 200 determines a customer-specific adjustment for each of the components (e.g., step 208). For example, the adjustment can lower prices for replacement components and/or provide more incentives for volume purchases to gain more business from the third customer. The adjustments can be input into a pricing system (e.g., step 210) to generate a future price for each of the components. Thus, for the third customer, the method 200 can optimize (e.g., maximize) sale profitability for one or more replacement components.

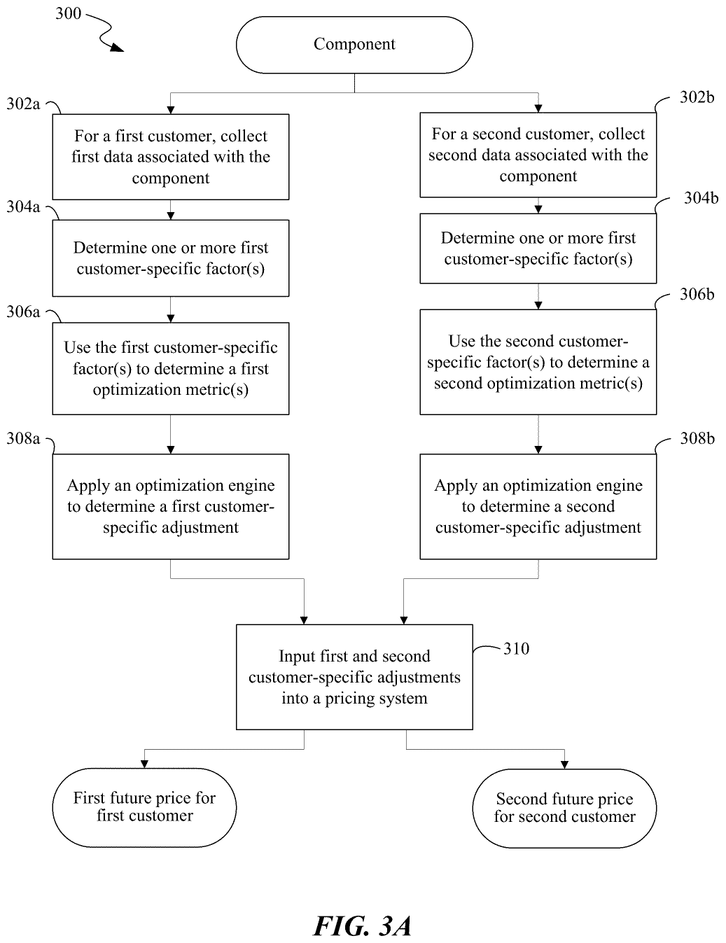

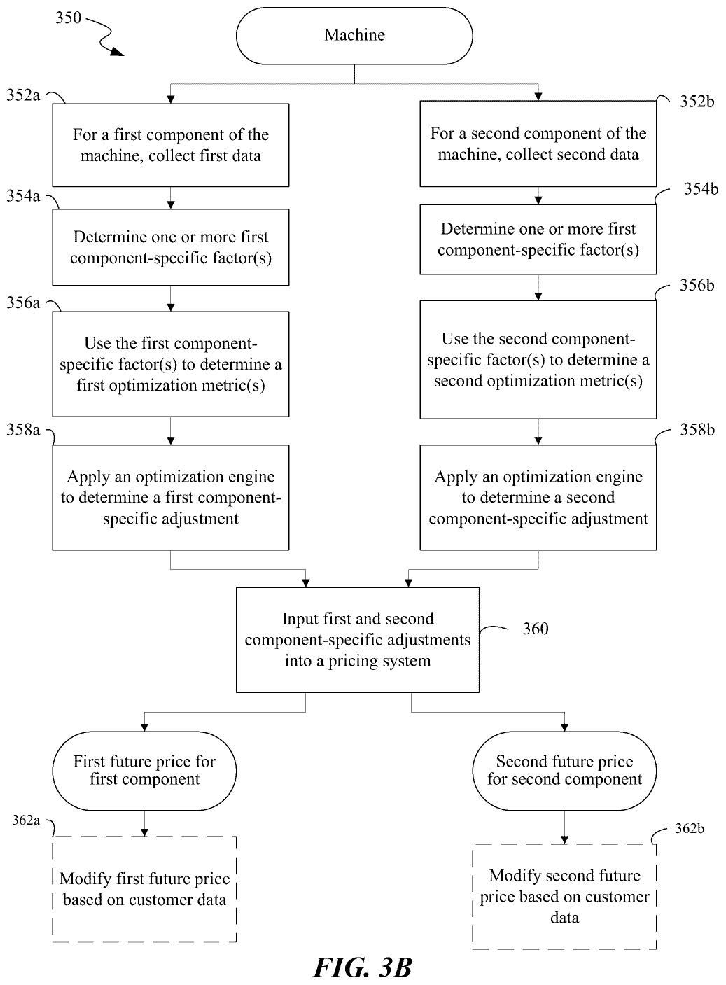

FIG. 3A is a block diagram illustrating a method 300 of determining customer-specific replacement component prices for a plurality of customers, in accordance with select embodiments of the present technology. The method 300 can include steps that are generally similar to or the same as steps of the method 200 of FIG. 2A. Accordingly, like numbers are used to indicate like steps (e.g., steps 302a and 302b versus step 202 of FIG. 2A), and a discussion of the method 300 will be limited to those features that differ from the method 300 of FIG. 3A and/or are necessary for context.

At step 302a, the method 300 can include collecting, for a component (e.g., the replacement component 120b), first customer data associated with the first customer. At step 304a, the method 300 can include determining one or more first customer-specific factors (e.g., customer-specific weights, customer-specific scores, etc.). At step 306a, the method 300 can include determining one or more first optimization metrics for the first customer based on the first customer-specific factors. At step 308a, the method 300 can include applying an optimization engine to the first optimization metric to determine a first customer-specific adjustment.

Steps 302b-306b can be generally similar to or the same as steps 302a-306a, but can correspond to second customer data associated with a second customer. Thus, while the second customer data is associated with a same component as the first customer data, the method 300 can determine second future price different than the first future price because the second customer (and the associated second customer data) can be different than the first customer (and the associated first customer data).

At step 302b, the method 300 can include collecting, for the replacement component, second customer data associated with the second customer. The second customer can be different than the first customer, such that the second customer data can be different than the first customer data. At step 304b, the method 300 can include determining one or more second customer-specific factors (e.g., customer-specific weights, customer-specific scores, etc.). The second customer-specific factors can be different than the first customer-specific factors. At step 306b, the method 300 can include determining one or more second optimization metrics for the second customer based on the second customer-specific factors. The one or more second optimization metrics can be different than the one or more first optimization metrics. At step 308b, the method 300 can include applying an optimization engine to the second optimization metric to determine a second customer-specific adjustment. The second customer-specific adjustment can be different than the first customer-specific adjustment.

At step 310, the method can include inputting the first and second customer-specific adjustments into a pricing system. Inputting the first customer-specific adjustment can generate, for the first customer, a first future price for the component. Inputting the second customer-specific adjustment can generate, for the second customer, a second future price for the component. Because the second customer data, the second optimization metric, and/or the second customer-specific adjustment can be different that the respective first customer data, optimization metric, and customer-specific adjustment, the second future price can be different than the first future price. Both the first and second future prices can be determined to optimize a price paid for, a quantity purchased, and/or a loyalty metric related to the component, as described previously. Accordingly, the method 300 can determine, for a plurality of customers, multiple optimal future prices for the component, each future price being specific to one of the plurality of customers. Although described in the context of two customers, in other embodiments the method 300 can include more customers. In at least some embodiments, for example, the method 300 can include at least three, five, ten, one hundred, one thousand, ten thousand, one hundred thousand, or any other suitable number of customers. Accordingly, compared to many pricing systems, replacement component pricing systems configured in accordance with embodiments of the present technology are expected to generate optimal, customer-specific prices for a high volume of customers (e.g., tens of thousands of customer) and replacement components (e.g., tens of thousands of replacement components).

FIG. 3B is a block diagram illustrating a method 300 of determining component-specific prices for components of a machine, in accordance with select embodiments of the present technology. The method 300 can include steps that are generally similar to or the same as steps of the method 200 of FIG. 2A. Accordingly, like numbers are used to indicate like steps (e.g., steps 352a and 352b versus step 202 of FIG. 2A), and a discussion of the method 350 will be limited to those features that differ from the method 350 of FIG. 3B and/or are necessary for context.

At step 352a, the method 350 can include collecting, for a machine (e.g., the machine 110), first component data associated with a first component of the machine. This can include, for example, any of the data described previously and with reference to step 202 that is related to the first component (e.g., quantity purchased, price paid, component fault codes, component historical patterns, etc.) but can be customer-independent or customer-agnostic (e.g., generally applicable for one or more customers).

At step 354a, the method 350 can include determining one or more first component-specific factors. This can be generally similar to or the same as the customer-specific factors described previously and with reference to step 204, such that the first component-specific factors can include one or more component-specific weights. Each of the component-specific weights can represent a prediction of how the associated first data influences or is correlated with the likelihood or probability that a replacement component generally similar to or the same as the first component is purchased. The first component-specific factors can further include one or more component-specific scores. Each of the component-specific scores can represent whether and/or to what extent each of the first data influence and/or are correlated with the likelihood that a replacement component generally similar to or the same as the first component is purchased.

At step 356a, the method 350 can include determining one or more first optimization metrics for the first component based on the first component-specific factors. This can be generally similar to or the same as determining the one or more first optimization metrics for the first customer in step 306a of FIG. 3A, but can be customer-independent or customer-agnostic.

At step 358a, the method 350 can include applying an optimization engine to the first optimization metric to determine a first component-specific adjustment. This can be generally similar to or the same as determining the first customer-specific adjust for the first customer in step 308a of FIG. 3A, but can be customer-independent and/or customer-agnostic.

Steps 352b-356b can be generally similar to or the same as steps 352a-356a, but can correspond to second component data associated with a second component. Thus, while the second component data is associated with a same machine as the first component data, the method 350 can determine a second future price different than the first future price because the second component (and the associated second component data) can be different than the first component (and the associated first component data).

At step 352b, the method 350 can include collecting, for the machine, second component data associated with the second component. The second component can be different than the first component, such that the second component data can be different than the first component data. At step 354b, the method 350 can include determining one or more second component-specific factors (e.g., second component-specific weight(s), second component-specific score(s), etc.). The second component-specific factors can be different than the first component-specific factors. At step 356b, the method 350 can include determining one or more second optimization metrics for the second component based on the second component-specific factors. The one or more second optimization metrics can be different than the one or more first optimization metrics. At step 358b, the method 350 can include applying an optimization engine to the second optimization metric to determine a second component-specific adjustment. The second component-specific adjustment can be different than the first component-specific adjustment.

At step 360, the method can include inputting the first and second component-specific adjustments into a pricing system. Inputting the first component-specific adjustment can generate, for the machine, a first future price for the first component. Inputting the second component-specific adjustment can generate, for the machine, a second future price for the second component. Because the second component data, the second optimization metric, and/or the second component-specific adjustment can be different that the respective first component data, optimization metric, and component-specific adjustment, the second future price can be different than the first future price. Accordingly, the method 350 can determine, for a plurality of components, multiple optimal future prices, each future price being specific to one of the plurality of components.

At step 362a, the method 350 can optionally further include modifying the first future price for the first component based on data associated with one or more customers (the “customer data”). The customer data can include any of the customer data described previously and with reference to FIG. 2, and can be associated with one or more customers. In some embodiments, the customer data can be generated by sorting or grouping the first and/or second component data (steps 352a, b, respectively) based on one or more customer identifiers, such as the customer identifiers described previously and with reference to FIG. 2A. Accordingly, in at least some embodiments, step 362a can include modifying the first future price (e.g., the first future customer-agnostic price) to determine one or more customer-specific prices for the first component, which can be generally similar to or the same as the method 200 of FIG. 2A.

At step 362b, the method 350 can optionally further include modifying the second future price for the second component based on customer data. This can be generally similar to or the same as step 362a, but for the second component rather than the first component.

Although described in the context of two components, in other embodiments the method 350 can include more components. In at least some embodiments, for example, the method 350 can include at least three, five, ten, one hundred, one thousand, ten thousand, one hundred thousand, or any other suitable number of components. Accordingly, compared to many pricing systems, replacement component pricing systems configured in accordance with embodiments of the present technology are expected to generate optimal, component-specific prices for a high volume of customers (e.g., tens of thousands of customer) and replacement components (e.g., tens of thousands of replacement components).

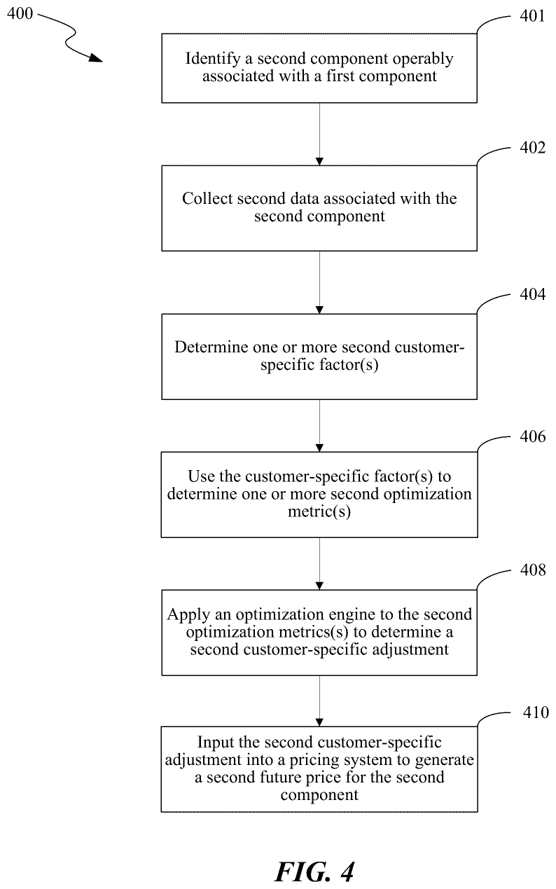

FIG. 4 is a block diagram illustrating a method of using a first customer-specific price for a first replacement component to determine a second customer-specific adjustment for a second component, in accordance with embodiments of the present technology. The method 400 can include one or more steps that are generally similar to or the same as the steps of the method 200 of FIG. 2A and/or the method 300 of FIG. 3. Accordingly, like numbers are used to indicate like steps (e.g., step 402 versus steps 302a-b of FIG. 3, step 202 of FIG. 2A), and a discussion of the method 400 will be limited to those features that differ from the method 200 of FIG. 2A, the method 300 of FIG. 3, and/or are necessary for context. Additionally, any element of the method 400 can be combined with the method 200 of FIG. 2A and/or the method 300 of FIG. 3.

At step 401, the method 400 includes identifying a second component operably associated with a first component. In some embodiments, the first component can be a component of a machine, and the second component can be another component of the machine. In some embodiments, the first component can be the component of step 202 (FIG. 2A) and/or the component of steps 302a-b (FIG. 3).

At step 402, the method 400 can include collecting, for the identified second component, second customer data associated with the second component. At step 404, the method 400 can include determining one or more second customer-specific factors (e.g., customer-specific weights, customer-specific scores, etc.). The second customer-specific factors can be different than the customer-specific factors determined for the first component. At step 406, the method 400 can include determining one or more second optimization metrics for the second component based on the second customer-specific factors. The one or more second optimization metrics can be different than the one or more optimization metrics determined for the first component. At step 408, the method 400 can include applying an optimization engine to the second optimization metric(s) to determine a second customer-specific adjustment. The second customer-specific adjustment can be different than the customer-specific adjustment determined for the first component.

The techniques disclosed herein can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions which may be used to cause a computer, a microprocessor, processor, and/or microcontroller (or other electronic devices) to perform a process. The machine-readable medium may include, but is not limited to, optical disks, compact disc read-only memories (CD-ROMs), magneto-optical disks, ROMs, random access memories (RAMs), crasable programmable read-only memories (EPROMs), electrically erasable programmable read-only memories (EEPROMs), magnetic or optical cards, flash memory, or other type of media/machine-readable medium suitable for storing electronic instructions.

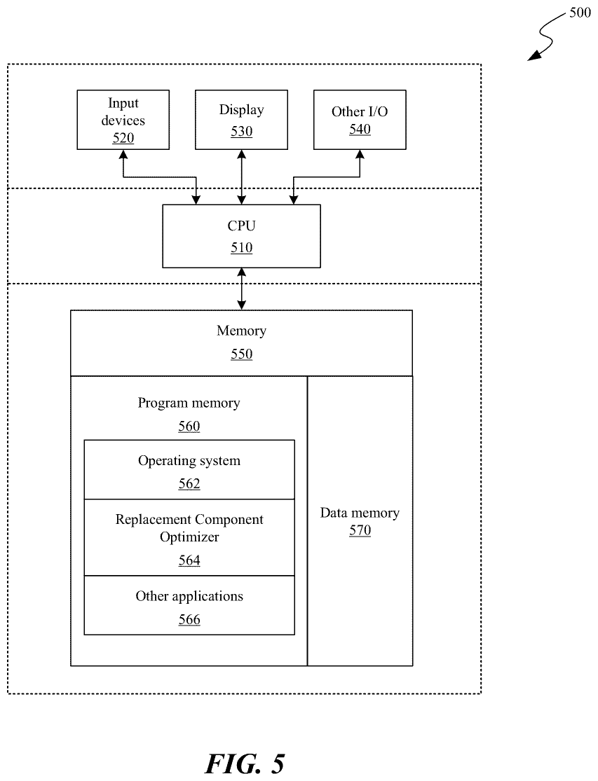

Several implementations are discussed below in more detail in reference to the figures. FIG. 5 is a block diagram illustrating an overview of devices on which some implementations of the disclosed technology can operate. The devices can comprise hardware components of a system or device 500 that determines optimal pricing for one or more components, for example. Device 500 can include one or more input devices 520 that provide input to the CPU (processor) 510, notifying it of actions. The actions are typically mediated by a hardware controller that interprets the signals received from the input device and communicates the information to the CPU 510 using a communication protocol. Input devices 520 include, for example, a mouse, a keyboard, a touchscreen, an infrared sensor, a touchpad, a wearable input device, a camera- or image-based input device, a microphone, or other user input devices.

CPU 510 can be a single processing unit or multiple processing units in a device or distributed across multiple devices. CPU 510 can be coupled to other hardware devices, for example, with the use of a bus, such as a PCI bus or SCSI bus. The CPU 510 can communicate with a hardware controller for devices, such as for a display 530. Display 530 can be used to display text and graphics. In some examples, display 530 provides graphical and textual visual feedback to a user. In some implementations, display 530 includes the input device as part of the display, such as when the input device is a touchscreen or is equipped with an eye direction monitoring system. In some implementations, the display is separate from the input device. Examples of display devices are: an LCD display screen; an LED display screen; a projected, holographic, or augmented reality display (such as a heads-up display device or a head-mounted device); and so on. Other I/O devices 540 can also be coupled to the processor, such as a network card, video card, audio card, USB, Fire Wire or other external device, sensor, camera, printer, speakers, CD-ROM drive, DVD drive, disk drive, or Blu-Ray device.

In some implementations, the device 500 also includes a communication device capable of communicating wirelessly or wire-based with a network node. The communication device can communicate with another device or a server through a network using, for example, TCP/IP protocols. Device 500 can utilize the communication device to distribute operations across multiple network devices.

The CPU 510 can have access to a memory 550. A memory includes one or more of various hardware devices for volatile and non-volatile storage, and can include both read-only and writable memory. For example, a memory can comprise random access memory (RAM), CPU registers, read-only memory (ROM), and writable non-volatile memory, such as flash memory, hard drives, floppy disks, CDs, DVDs, magnetic storage devices, tape drives, device buffers, and so forth. A memory is not a propagating signal divorced from underlying hardware; a memory is thus non-transitory. Memory 550 can include program memory 560 that stores programs and software, such as an operating system 562, Replacement Component Optimizer 564 (which may include instructions for carrying out the methods of determining optimal, customer-specific replacement component prices disclosed herein), and other application programs 566. Memory 550 can also include data memory 570 that can include database information, etc., which can be provided to the program memory 560 or any element of the device 500.

Some implementations can be operational with numerous other general purpose or special purpose computing system environments or configurations. Examples of well-known computing systems, environments, and/or configurations that may be suitable for use with the technology include, but are not limited to, personal computers, server computers, handheld or laptop devices, cellular telephones, mobile phones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

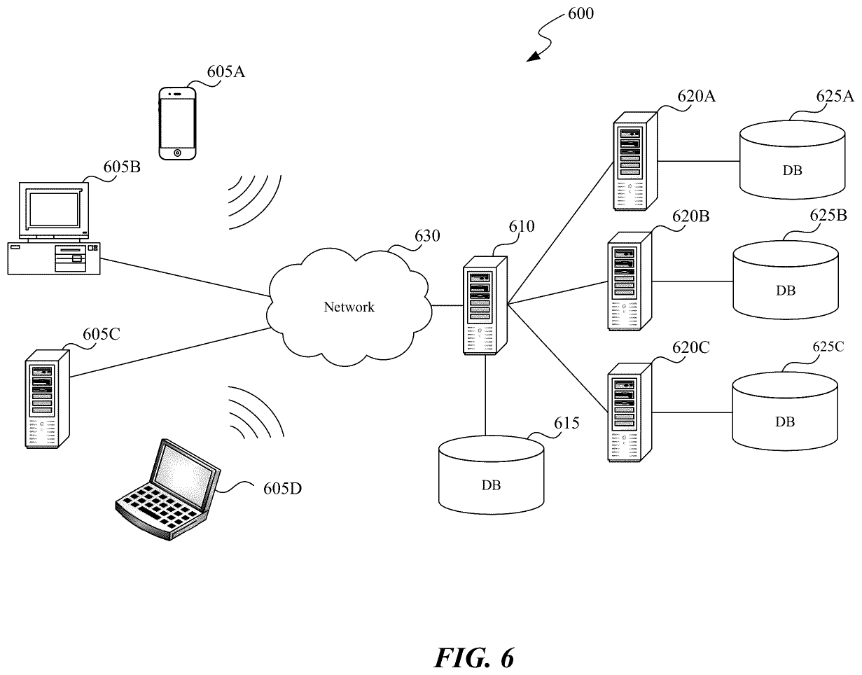

FIG. 6 is a block diagram illustrating an overview of an environment 600 in which some implementations of the disclosed technology can operate. Environment 600 can include one or more client computing devices 605A-D, examples of which can include device 500. Client computing devices 605 can operate in a networked environment using logical connections through network 630 to one or more remote computers, such as a server computing device 610.

In some implementations, server computing device 610 can be an edge server that receives client requests and coordinates fulfillment of those requests through other servers, such as servers 620A-C. Server computing devices 610 and 620 can comprise computing systems, such as device 500. Though each server computing device 610 and 620 is displayed logically as a single server, server computing devices can each be a distributed computing environment encompassing multiple computing devices located at the same or at geographically disparate physical locations. In some implementations, each server computing device 620 corresponds to a group of servers.

Client computing devices 605 and server computing devices 610 and 620 can each act as a server or client to other server/client devices. Server 610 can connect to a database 615. Servers 620A-C can each connect to a corresponding database 625A-C. As discussed above, each server 620 can correspond to a group of servers, and each of these servers can share a database or can have their own database. Databases 615 and 625 can warehouse (e.g., store) information. Though databases 615 and 625 are displayed logically as single units, databases 615 and 625 can each be a distributed computing environment encompassing multiple computing devices, can be located within their corresponding server, or can be located at the same or at geographically disparate physical locations.

Network 630 can be a local area network (LAN) or a wide area network (WAN), but can also be other wired or wireless networks. Network 630 may be the Internet or some other public or private network. Client computing devices 605 can be connected to network 630 through a network interface, such as by wired or wireless communication. While the connections between server 610 and servers 620 are shown as separate connections, these connections can be any kind of local, wide area, wired, or wireless network, including network 630 or a separate public or private network.

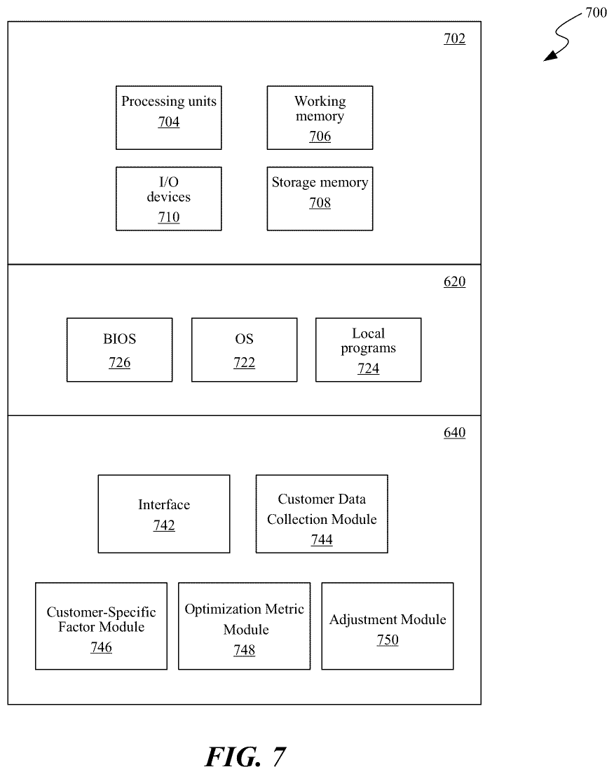

FIG. 7 is a block diagram illustrating elements 700 which, in some implementations, can be used in a system employing the disclosed technology. The elements 700 include hardware 702, general software 720, and specialized elements 740. As discussed above, a system implementing the disclosed technology can use various hardware, including processing units 704 (e.g., CPUs, GPUS, APUs, etc.), working memory 706, storage memory 708, and input and output devices 710. Elements 700 can be implemented in a client computing device such as client computing devices 605 or on a server computing device, such as server computing device 610 or 620.

General software 720 can include various applications, including an operating system 722, local programs 724, and a basic input output system (BIOS) 726. Specialized components 740 can be subcomponents of a general software application 720, such as local programs 724, which may include the Replacement Component Optimizer 564 (see FIG. 5 and description above). Specialized elements 740 can include a Customer Data Collection Module 744, a Customer-Specific Factor Module 746, an Optimization Metric Module 748, an Adjustment Module 750, and components that can be used for transferring data and controlling the specialized components, such as interface 742. In some implementations, elements 700 can be in a computing system that is distributed across multiple computing devices or can be an interface to a server-based application executing one or more of specialized elements 740.

Those skilled in the art will appreciate that the components illustrated in FIGS. 5-7 described above, and in each of the flow diagrams discussed above, may be altered in a variety of ways. For example, the order of the logic may be rearranged, sub steps may be performed in parallel, illustrated logic may be omitted, other logic may be included, etc. In some implementations, one or more of the components described above can execute one or more of the processes described herein.

### INDUSTRIAL APPLICABILITY

In some embodiments, systems for determining optimal, customer-specific component prices can include Customer Data Collection Module 744, a Customer-Specific Factor Module 746, an Optimization Metric Module 748, an Adjustment Module 750 (FIG. 7).

In operation, the Customer Data Collection Module 744 collects and stores the customer data (see step 202 in FIGS. 2A and 2B, steps 302a-b in FIG. 3, step 402 in FIG. 4) related to a component of a machine. The Customer-Specific Factor Module 746 can determine one or more customer-specific factors based on the customer data (see step 204 in FIG. 2A, steps 204a-b in FIG. 3, step 402 in FIG. 4). In at least some embodiments, for example, the Customer-Specific Factor Module 746 can include the weight-determining engine and/or the score-determining engine described previously. The Optimization Metric Module 748 calculates one or more optimization metrics based on the customer-specific factors (see step 206 in FIG. 2A, steps 306a-b in FIG. 3, step 406 in FIG. 4). The Adjustment Module 748 can apply an optimization engine to the optimization metric(s) to determine one or more customer-specific adjustments (see step 208 in FIG. 2A, steps 308a-b in FIG. 3, step 408 in FIG. 4). The optimization engine can be programmed to optimize (e.g., maximize), for individual ones of the one or more customers, a price paid for, a quantity purchased, a loyalty metric related to the component, and/or any of the other customer data described previously. The Adjustment Module 748 can additionally input the customer-specific adjustment(s) into a pricing system to generate one or more future prices for the component (see step 210 in FIG. 2A, step 308 in FIG. 3, step 410 in FIG. 4). General software 720 (see FIG. 7) may include instructions to repeat one or more steps the method(s) described herein (e.g., the method 200 of FIG. 2A, the method 300 of FIG. 3, and/or the method 400 of FIG. 4) at selected increments of time to continually or periodically update the customer data, the customer-specific factor(s), the optimization metric(s), and/or the customer-specific adjustment(s).

The disclosed technology, therefore, provides optimal, customer-specific pricing for one or more components, such as replacement components. The disclosed technology can thereby optimize (e.g., maximize) one or more aspects of a future transaction involving individual ones of the one or more components, such as a price paid and/or a quantity purchased. In particular, the disclosed technology can account for past prices paid, past quantities purchased, past loyalty metrics, and other forms of customer data described herein to determine customer-specific optimization metrics, such as customer-specific weights and/or scores, and a pricing optimization engine can use the customer-specific optimization metrics to determine, for one or more customers, customer-specific adjustments for individual ones of the one or more components. Many replacement component pricing systems typically include a large volume (e.g., hundreds, thousands, etc.) of replacement components and customers, and are generally not capable of determining optimized prices for each replacement component that are also customer-specific. In contrast to many replacement component pricing systems, the disclosed technology can determine customer specific prices for a large volume of replacement component and customers. Additionally, compared to many replacement component pricing systems, the disclosed technology is expected determine optimized, customer-specific prices for each of the component with increased accuracy.

The above description and drawings are illustrative and are not to be construed as limiting. Numerous specific details are described to provide a thorough understanding of the disclosure. However, in some instances, well-known details are not described in order to avoid obscuring the description. Further, various modifications may be made without deviating from the scope of the embodiments. The headings provided herein are for convenience only and do not necessarily affect the scope of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” (or the like) in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. It will be appreciated that the same thing can be said in more than one way. Consequently, alternative language and synonyms may be used for any one or more of the terms discussed herein, and any special significance is not to be placed upon whether or not a term is elaborated or discussed herein. Synonyms for some terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification. Unless otherwise defined, all technical and scientific terms used herein have the same meaning as commonly understood by one of ordinary skill in the art to which this disclosure pertains. In the case of conflict, the present document, including definitions, will control.

As used herein, the term “and/or” when used in the phrase “A and/or B” means “A, or B, or both A and B.” A similar manner of interpretation applies to the term “and/or” when used in a list of more than two terms.

I/We claim:

1. A method for improving a functioning of a machine by preventing a machine fault from occurring, the method comprising:
collecting, for one or more users, data associated with a replacement component of the machine, wherein the data includes—
component usage data for the replacement component collected using a sensor, component fault codes, machine usage times, machine usage locations, and machine fault codes; and
improving the functioning of the machine by preventing the machine fault from occurring by determining for each of the one or more users a user-specific optimization metric to optimize by—
determining, for each of the data associated with the one or more users, a user-specific weight by running a classification machine learning model to categorize the data including the component usage data collected using the sensor into high, medium, and low likelihood that the replacement component is needed;
determining, for each of the data associated with the one or more users, a user-specific score indicating a correlation between each of the data and a likelihood that the replacement component is needed;
based on the user-specific weight and the user-specific score, creating a ranked list of each of the data;
determining the user-specific optimization metric to optimize based on the ranked list; and
improving the functioning of the machine by preventing the machine fault from occurring by applying an optimization engine to the user-specific optimization metric for each of the data to predict the likelihood that the replacement component is needed.

2. The method of claim 1, wherein the optimization engine includes one or more machine learning models, deep learning models, deep learning models including optimization with gradient boosting, Monte Carlo simulations for sales probability, and/or or decision trees for combining metrics.

3. The method of claim 1, wherein the data further includes machine sales data and/or machine telematics data.

4. The method of claim 1, wherein:
the one or more users includes a first user and a second user,
one or more optimization metrics includes a first optimization metric and a second optimization metric,
the first optimization metric is specific to the first user, and
the second optimization metric is specific to the second user and different than the first optimization metric.

5. The method of claim 4, wherein:
applying the optimization engine to the first optimization metric determines a first user-specific adjustment for the first user, and
applying the optimization engine to the second optimization metric determines a second user-specific adjustment for the second user,
wherein the second user-specific adjustment is different than the first user-specific adjustment.

6. The method of claim 1, wherein the data includes a comparison of expected purchases versus actual purchases of the replacement component over an operational life of the machine.

7. The method of claim 1, wherein the replacement component is a first replacement component, the method further comprising:
identifying a second replacement component operably associated with the first replacement component; and
improving the functioning of the machine by preventing the machine fault from occurring by applying the optimization engine to the user-specific optimization metric to predict the likelihood that the second replacement component is needed.

8. A non-transitory, computer-readable medium storing computer-executable instructions that, when executed by one or more processors, cause the one or more processors to perform a method comprising:
collecting, for one or more users, data associated with a replacement component of a machine, wherein the data includes—
component usage data for the replacement component collected using a sensor, component fault codes, machine usage times, machine usage locations, or machine fault codes; and
improving a functioning of the machine by preventing a machine fault from occurring by determining for each of the one or more users a user-specific optimization metric to optimize by—
determining, for each of the data associated with the one or more users, a user-specific weight by running a classification machine learning model to categorize the data including the component usage data collected using the sensor into high, medium, and low likelihood that the replacement component is needed;
determining, for each of the data associated with the one or more users, a user-specific score indicating a correlation between each of the data and a likelihood that the replacement component is needed;
determining the user-specific optimization metric to optimize based on the user-specific weight and the user-specific score; and
improving the functioning of the machine by preventing the machine fault from occurring by applying an optimization engine to the user-specific optimization metric for each of the data to predict the likelihood that the replacement component is needed.

9. The non-transitory, computer-readable medium of claim 8, wherein:
the one or more users includes a first user and a second user,
a one or more optimization metrics includes a first optimization metric and a second optimization metric,
the first optimization metric is specific to the first user, and
the second optimization metric is specific to the second user and different than the first optimization metric.

10. The non-transitory, computer-readable medium of claim 9, wherein:
applying one or more component optimization engines to the first optimization metric determines a first user-specific adjustment for the first user, and
applying the one or more component optimization engines to the second optimization metric determines a second user-specific adjustment for the second user and different than the first user-specific adjustment.

11. The non-transitory, computer-readable medium of claim 8, wherein the replacement component is a first replacement component, the method further comprising:
identifying a second replacement component operably associated with the first replacement component; and
improving the functioning of the machine by preventing the machine fault from occurring by applying the optimization engine to the user-specific optimization metric to predict the likelihood that the second replacement component is needed.

12. The method of claim 8, wherein the optimization engine includes one or more machine learning models, deep learning models, deep learning models including optimization with gradient boosting, Monte Carlo simulations for sales probability, and/or or decision trees for combining metrics.

13. The method of claim 8, wherein the data further includes machine sales data and/or machine telematics data.

14. A system comprising:
at least one hardware processor; and
at least one non-transitory memory storing instructions, which, when executed by the at least one hardware processor, cause the system to:
collect, for one or more users, data associated with a replacement component of a machine, wherein the data includes—
component usage data for the replacement component collected using a sensor, component fault codes, machine usage times, machine usage locations, and machine fault codes; and
prevent a machine fault from occurring by determining for each of the one or more users a user-specific optimization metric to optimize by—
determining, for each of the data associated with the one or more users, a user-specific weight by running a classification machine learning model to categorize the data including the component usage data collected using the sensor into high, medium, and low likelihood that the replacement component is needed;
determining, for each of the data associated with the one or more users, a user-specific score indicating a correlation between each of the data and a likelihood that the replacement component is needed;
based on the user-specific weight and the user-specific score, creating a ranked list of each of the data;
determining the user-specific optimization metric to optimize based on the ranked list; and
preventing the machine fault from occurring by applying an optimization engine to the user-specific optimization metric for each of the data to predict the likelihood that the replacement component is needed.

15. The system of claim 14, wherein the optimization engine includes one or more machine learning models, deep learning models, deep learning models including optimization with gradient boosting, Monte Carlo simulations for sales probability, and/or or decision trees for combining metrics.

16. The system of claim 14, wherein the data further includes machine sales data and/or machine telematics data.

17. The system of claim 14, wherein:
the one or more users includes a first user and a second user,
one or more optimization metrics includes a first optimization metric and a second optimization metric,
the first optimization metric is specific to the first user, and
the second optimization metric is specific to the second user and different than the first optimization metric.

18. The system of claim 17, comprising instructions to:
apply the optimization engine to the first optimization metric determines a first user-specific adjustment for the first user, and
apply the optimization engine to the second optimization metric determines a second user-specific adjustment for the second user,
wherein the second user-specific adjustment is different than the first user-specific adjustment.

19. The system of claim 14, wherein the data includes a comparison of expected purchases versus actual purchases of the replacement component over an operational life of the machine.

20. The system of claim 14, wherein the replacement component is a first replacement component, comprising instructions to:
identify a second replacement component operably associated with the first replacement component; and
prevent the machine fault from occurring by applying the optimization engine to the user-specific optimization metric to predict the likelihood that the second replacement component is needed.
